(19) United States
(12) Patent Application Publication
(10) Pub. No.: US 2006/0069825 A1
(43) Pub. Date: Mar. 30, 2006

(54) Method and system of transferring firmware from a host device to a printing device

(76) Inventor: Leonard B. Hodder, Toronto (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/949,871

(22) Filed: Sep. 24, 2004

(51) Int. Cl. G06F 13/38

(52) U.S. Cl. 710/72

(57) ABSTRACT

A method of transferring firmware from a host device to a printing device includes sending data blocks forming the firmware to the printing device in succession. Each data block is sent only upon confirmation of receipt of the previously sent data block. Upon receipt of a priority task destined for the printing device, sending of the data blocks is suspended and the priority task is transmitted to the printing device. Upon completion of the priority task, sending of the data blocks is automatically resumed.

### FIELD OF THE INVENTION

The present invention relates generally to printing devices and in particular, to a method and system of transferring firmware from a host device to a printing device.

### BACKGROUND OF THE INVENTION

Stand-alone electronic cash registers including payment card readers and receipt printers have been used for years in stores, retail outlets and service outlets to facilitate the completion of cash, cheque, credit card or debit card transactions for the purchase of goods and/or services. With the advent of sophisticated and inexpensive computing equipment, input devices and secure communication networks, point-of-sale (POS) stations have become an increasingly popular alternative.

POS stations typically include a host device and a plurality of interchangeable peripherals connected to the host device. The host device and peripherals are easily integrated allowing the configuration of POS stations to be modified to meet changing needs. This has been another factor leading to their widespread acceptance. The host device is commonly in the form of a personal computer. The peripherals often include a keyboard, a display screen, a cash drawer, a printing device, a payment card reader and a barcode reader. In some cases, a touch-sensitive display screen is used instead of separate keyboard and display screen peripherals.

As is well known, the host device communicates with the peripherals and executes software to allow product and/or service transactions to be completed. When payment is effected using a debit or credit card, the host device establishes a connection to the appropriate financial institution over an information network so that approval for the transaction may be obtained. Upon completion of any transaction, the host device creates and transmits a print job to the printing device causing the printing device to generate a transaction receipt and a possibly signing receipt, if payment is made using a credit card.

In larger stores, retail outlets and service outlets, POS stations are typically linked via a local area network and communicate with a backend computing device that maintains a database for transaction, inventory, accounting, sales, tax, etc. information. Transaction data received by each of the POS stations is conveyed to the backend computing device for storage in the database allowing all transaction data to be stored in a common location. Collectively storing all transaction data in one common location allows retailers to track, account for and maintain inventory, collected taxes and pricing information. Also, by linking the POS stations, updates relating to sales on products and/or services, tax, etc. can be communicated to each POS station over the local area network avoiding the need to update the POS stations one at a time.

Printing devices commonly used in POS stations comprise a printer having a slot for receiving a separate printer interface that controls communications between the host device and the printer. The printer interface is primarily selected based on the communication protocol used by the host device thereby to ensure hardware compatibility between the host device and the printer. For example, hardware compatibility may be achieved by installing a serial, parallel, Ethernet or USB interface into the printer slot. As the printer interface can be readily changed, the printer is not limited for use with any particular communication protocol but rather can be used in many different communication protocol environments simply by replacing the printer interface. The printer interface may also be selected to enhance functionality of the printer such as by adding supplemental fonts or by emulating one or more other printer models.

The printer interface and the printer are typically preloaded with firmware although the printing device may receive updated printer firmware from the host device to replace or patch the existing printer firmware. The printer firmware typically includes a boot file, a main firmware file and one or more font files. The boot file is executed by the printer during initialization to place the printer into a ready operating state. The main firmware and font files are executed during normal operation of the printer to allow the printer to respond to print commands received from the host device via the printer interface so that appropriate transaction receipts can be printed. The font file typically contains glyph or shape data for each character, in the font file character sets.

In many instances it is desired to upgrade the printing device to allow the printing device to print receipts in different formats and/or languages, to support additional functionality and/or to enhance performance. This often requires the firmware resident in the printing device to be replaced.

Firmware and/or font files can be very large and accordingly transmission of such files from the host device to the printing device can take a significant amount of time and can occupy printing device resources to the extent that the printing device becomes unavailable for executing print jobs. As will be appreciated, in the retail environment processing transactions quickly and efficiently is of a primary concern to maintain customer satisfaction and profitability at desired levels.

Techniques have been considered to handle printer firmware and print job conflicts. For example, U.S. Patent Application Publication No. 2003/0011816 to Ikeno discloses a control method for preventing conflict between resource data downloads such as font data, and print jobs. The printing apparatus stores updateable resource data and includes reception control means that stops reception of a new print job when resource data is being received. An update unit updates the resource data when it is determined that received and queued print jobs have been completed.

U.S. Pat. No. 6,640,334 to Rasmussen discloses a method and apparatus for remotely updating firmware in a communication device. A message channel is used for a firmware upload simultaneously with the data traffic of user-initiated communications sessions, in order to complete the entire upload without inconveniencing the user of the device. The firmware is broken into small blocks, each having a unique sequence number. If power is lost or an off-line condition occurs, the sequence numbers assigned to the blocks are used to resume transfer of the firmware at the point of interruption.

U.S. Pat. No. 5,220,674 to Morgan et al. discloses a local area print server that is capable of requesting and storing required resource data such as font files and forms. When a print request requires, for instance, a particular font file that is not resident on the print server, the print server requests and obtains the font file via a network from a resource server or other print server. A server job controller blocks transmission of print data messages for a printing client while requesting a resource from the resource server.

Although the above references disclose techniques for handling printer firmware and print job conflicts, improvements are desired. It is therefore an object of the present invention to provide a novel method and system of transferring firmware from a host device to a printing device.

### SUMMARY OF THE INVENTION

Accordingly, in one aspect of the present invention there is provided a method of transferring firmware from a host device to a printing device. During the method, firmware data blocks forming the firmware are sent to the printing device in succession. In the event of an interruption, sending of the data blocks is suspended. Upon completion of the interruption, sending of the data blocks is resumed while avoiding re-sending previously sent data blocks.

In one embodiment, sending of the data blocks is suspended every time an interruption occurs. The interruption may be in the form of a power outage. In this case, sending of the data blocks is resumed automatically upon power restoration. The interruption may also be a print job destined for the printing device. In the event of a print job, the print job is sent to the printing device while the sending of the data blocks is suspended. Sending of the data blocks is resumed automatically upon completion of the print job.

According to another aspect of the present invention there is provided a method of transferring firmware from a host device to a printing device. During the method, data blocks forming the firmware are sent to the printing device in succession. Each data block is sent only upon confirmation of receipt of the previously sent data block. Upon receipt of a priority task destined for the printing device, the sending of the data blocks is suspended and the priority task is transmitted to the printing device. Upon completion of the priority task, the sending of the data blocks is automatically resumed.

The sending of the data blocks may be suspended immediately upon receipt of the priority task or may be suspended upon receipt of confirmation of the last sent data block. Each data block received by the printing device is verified prior to the confirmation being generated and sent to the host device. During verification, each data block is checked for at least one of checksum errors, format errors and sequence errors.

During the method, following a transmission interruption, sending of the data blocks is resumed automatically at the point where sending was interrupted.

According to yet another aspect of the present invention there is provided in a point-of-sale system including a host device and at least one printing device including a printer interface and a printer, a method of updating firmware stored in the printing device. During the method, at the host device, firmware is segmented into a sequence of data blocks. The data blocks of the sequence are transmitted in succession to the printing device with each successive data block being transmitted only upon verification of the previously sent data block by the printing device. Transmission of the data blocks is suspended upon receipt of each print job destined for the printing device. Each print job is transmitted to the printing device and upon completion of each print job, transmission of the data blocks is automatically resumed thereby to complete updating of the firmware without delaying processing of print jobs destined for the printing device.

According to still yet another aspect of the present invention there is provided a system comprising a printing device executing firmware stored therein and responsive to print jobs to print information on a medium. A host device generates print jobs for transmission to the printing device. The host device executes a firmware update procedure when firmware in the printing device is to be updated. During the firmware update procedure, the host device sends updated firmware in successive blocks to the printing device. The host device suspends the firmware update procedure when a print job is generated for the printing device and resumes the firmware update procedure automatically upon completion of the print job.

The present firmware update procedure ensures print jobs are given higher priority than firmware updates. As a result, when a print job is to be carried out and a firmware update is in progress, the firmware update is automatically suspended allowing the print job to be processed quickly and efficiently. The firmware update is automatically resumed upon completion of the print job at the point where the firmware update was suspended. The firmware update also automatically resumes following an interruption such as for example a power outage or hardware reset.

### BRIEF DESCRIPTION OF THE DRAWINGS

Embodiments will now be described more fully with reference to the following drawings, in which:

FIG. 1 is a schematic block diagram of a point-of-sale station including a host device and a printing device;

FIG. 2 is a schematic block diagram of the printing device of FIG. 1;

FIGS. 3 and 4 are flow charts showing the steps performed during transferring of printer firmware for the host device to the printing device; and

FIGS. 5 to 7 are sequence diagrams showing operation of the host device and printing device during transferring of printer firmware from the host device to the printing device under a number of operating conditions.

### DETAILED DESCRIPTION OF THE EMBODIMENTS

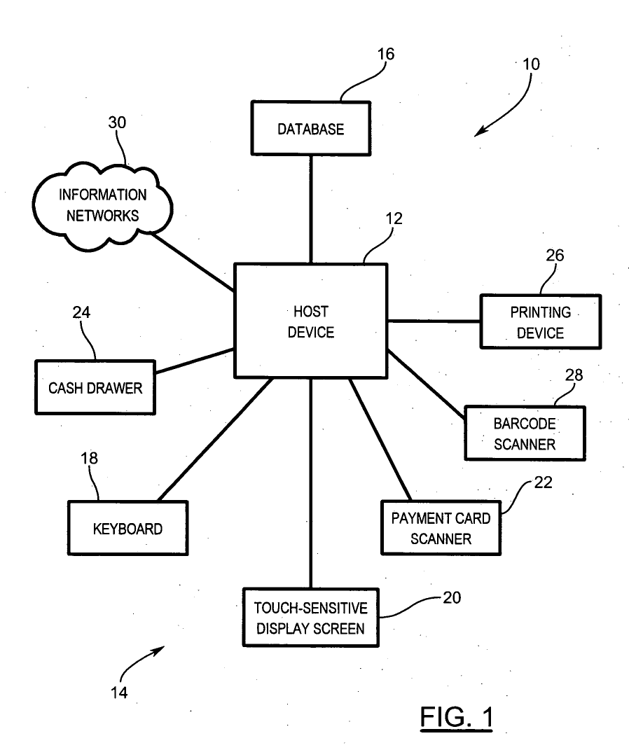

Turning now to FIG. 1, a point-of-sale (POS) station is shown and is generally identified by reference numeral 10. As can be seen, POS station 10 includes a microprocessor-based host device 12 in the form of a personal computer that communicates with a plurality of peripherals generally identified by reference numeral 14 and with a database 16 storing transaction, inventory, pricing, tax and accounting information. In this example, peripherals 14 include a keyboard 18, a touch-sensitive display screen 20, a payment card scanner 22, a cash drawer 24, a printing device 26 and a barcode scanner 28. Host device 12 also communicates with financial institutions (not shown) such as banks and credit card companies over one or more information networks generally identified by reference numeral 30.

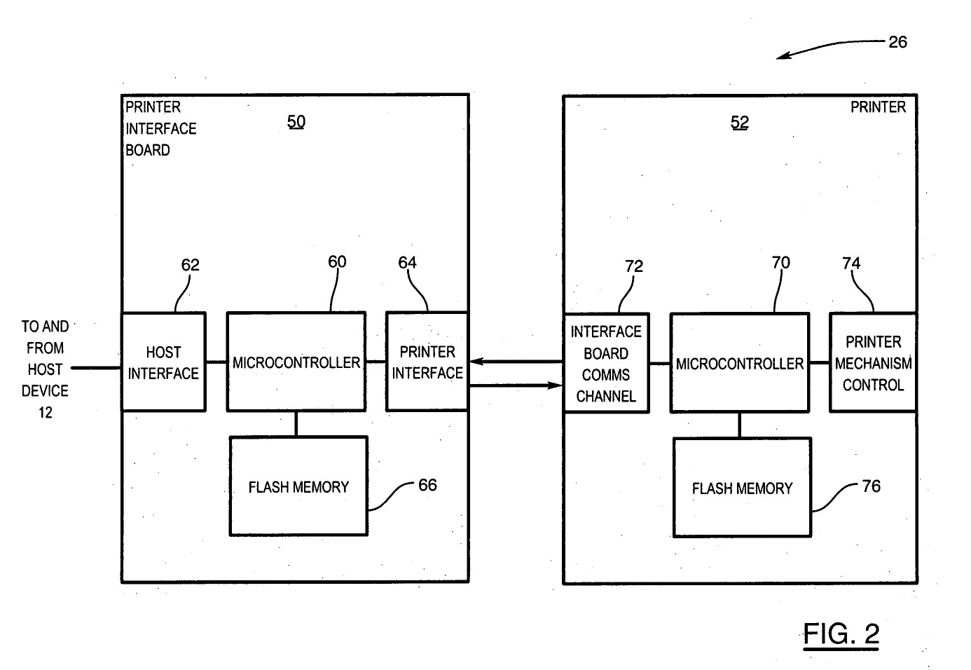

Printing device 26 is best illustrated in FIG. 2 and includes a printer interface 50 and a printer 52. Printer interface 50 comprises a microcontroller 60, a host interface board 62, a printer interface board 64 and non-volatile flash NAND memory 66. Printer 52 comprises a microcontroller 70, a communications channel interface board 72, a printer control mechanism 74 and non-volatile flash NAND memory 76. For example, the printer interface 50 may be of the type sold by EPSON under Model No. UB-EML and the printer 52 may be of the type sold by EPSON under Model No. TM-U200.

The non-volatile memory 66 stores printer interface firmware that is executed by the microcontroller 60 during initialization and operation of the printing device 26 to permit communications between the host device 12 and the printer 52 and optionally, to enhance operation of the printer by storing supplemental font files that allow the printer characters of different style and/or size and/or emulation files that allow the printer to emulate one or more other printer models.

The non-volatile memory 76 stores printer firmware that is executed by the microcontroller 70 during initialization and operation of the printing device 26 to allow the printer 52 to respond to commands generated by the host device 12 and print appropriate receipts when a transaction is completed. In this particular embodiment, the printer firmware includes a boot file, a main firmware file and a font file. The firmware also includes printer hardware and firmware identification information to enable the printer interface 50 to determine the type of the printer 52 and the status of the resident printer firmware. For example, the printer hardware and firmware identification information includes the version string of the main firmware file, the version string of the boot file, the version of the font file and the printer model identification number (ID). The printer model ID is a single data byte, the value of which is unique to the printer.

As mentioned above, in some instances it is desired to update the printer interface and/or printer firmware stored in the non-volatile memory of the printer interface and printer. In the case of printer firmware updates, such updates can be initiated by the host device 12 or by the printer interface 50, if the printer 52 is fitted with a printer interface 50 that is loaded with updated printer firmware.

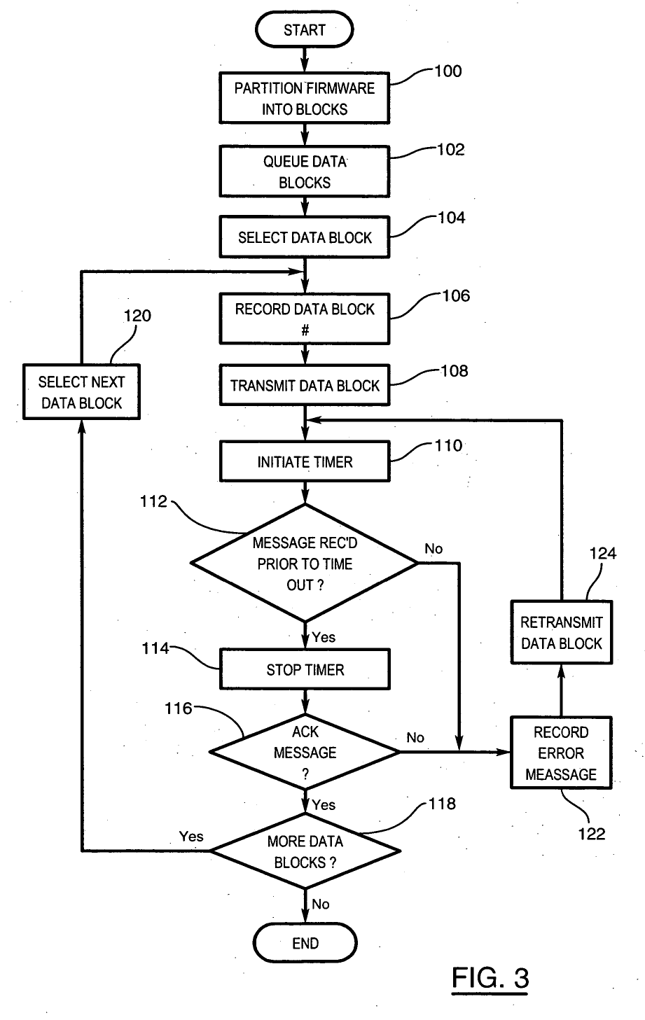

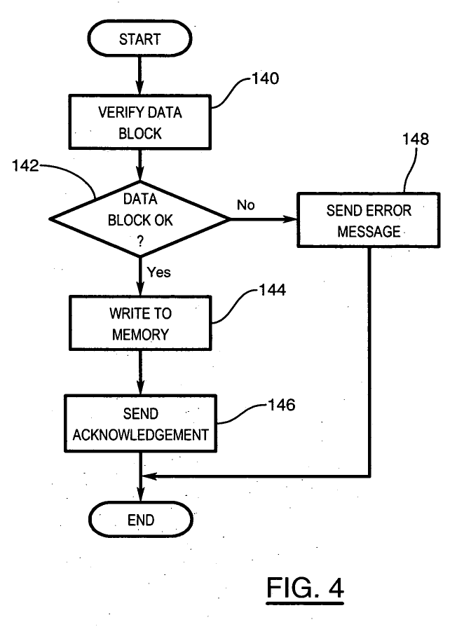

When a firmware update is initiated by the host device 12, the host device 12 commences a firmware update procedure. FIGS. 3 and 4 illustrate the steps performed during the firmware update procedure. As can be seen, initially the host device 12 partitions the updated firmware to be downloaded to the printing device 26 into sequential data blocks (step 100) and places the data blocks in a queue for transmission to the printing device 26 (step 102). The host device 12 in turn selects the first data block DB₀ in the queue (step 104), records the number of the selected data block (step 106) and transmits the selected data block DB₀ to the printer interface 50 of the printing device 26 (step 108). The host device 12 also initiates a timer (step 110) and awaits receipt of a return message from the printing device 26 before the timer times out (step 112).

When a return message is received from the printing device 26 before the timer times out, the host device stops the timer (step 114) and checks the return message to determine its type (step 116). If the return message is an acknowledgement message signifying proper receipt of the transmitted data block, the host device 12 checks the queue to determine if the queue holds one or more data blocks to be transmitted to the printing device 26 (step 118). If the queue holds one or more data blocks DB_{N}, the host device 12 selects the next sequential data block in the queue (step 120) before returning to step 106 and repeating the process.

At step 116, if the return message is an error message, the host device 12 records the error message (step 122) and re-transmits the selected data block (step 120) before returning to step 110.

At step 112, if a return message is not received from the printing device 26 before the timer times out, the host device 12 also records an error message (step 120) and retransmits the selected data block (step 120) before returning to step 110.

As will be appreciated, the above process is performed until all of the data blocks in the queue have been transmitted to the printing device 26 and acknowledged by the printing device. The host device 12 or printer interface 50 will however break a data block resending loop if a threshold of number of error messages or some other similar condition is reached.

Upon receipt of a data block DB_{N} from the host device 12, the microcontroller 60 of the printer interface 50 verifies the received data block (steps 140 and 142). During verification, the microcontroller 60 checks the received data block to ensure it does not contain a checksum error, checks the font identification number (ID) and checks the data block format to ensure the format is valid. The microcontroller 60 also checks the sequence number of the received data block to ensure the data block is received in proper order.

If the received data block is properly verified, the microcontroller 60 writes the data block in the non-volatile memory 66 (step 144) and sends an acknowledgement message to the host device 12 (step 146). If the received data block is a duplicate of the last properly verified data block (which may have been sent as a result of the host device 12 not receiving the acknowledgement message from the printer interface 50 prior to the timer timing out), the microcontroller 60 overwrites the previously verified data block with the duplicate data block. If the received data block is not verified, the microcontroller 60 sends an error message to the host device 12 (step 148). The error message transmitted by the microcontroller 60 provides an indication concerning the type of error encountered during verification of the data block. In this manner, the host device 12 can maintain statistics relating to errors encountered during firmware updates.

If at anytime during the firmware update procedure the host device 12 receives a print job, the host device 12 immediately suspends the firmware update procedure and carries out the print job. Once the print job has been carried out, the host device 12 automatically resumes the firmware update procedure starting from the point where the firmware update procedure was interrupted. This is possible due to the fact that at step 106, the host device 12 records the selected data block in the queue that is in the process of being transmitted to the printing device 26. The host device 12 simply resumes transmitting the data blocks in the queue starting with the last selected data block that was recorded at step 106 for which a return acknowledgement message has not been received.

The firmware update procedure is suspended each time the host device 12 receives a print job to be carried out by the printing device 26. Thus, during the course of a firmware update, the firmware update procedure may be suspended any number of times to accommodate processing of print jobs. As will be appreciated, by suspending the firmware update procedure in this manner, print jobs are given priority thereby to allow transactions to be processed quickly and efficiently.

If a power interruption or other interruption such as a hardware reset occurs during the firmware update procedure, when the interruption ends and power is restored or the hardware resets, the host device 12 similarly resumes the firmware update procedure from the point where the firmware update procedure was interrupted.

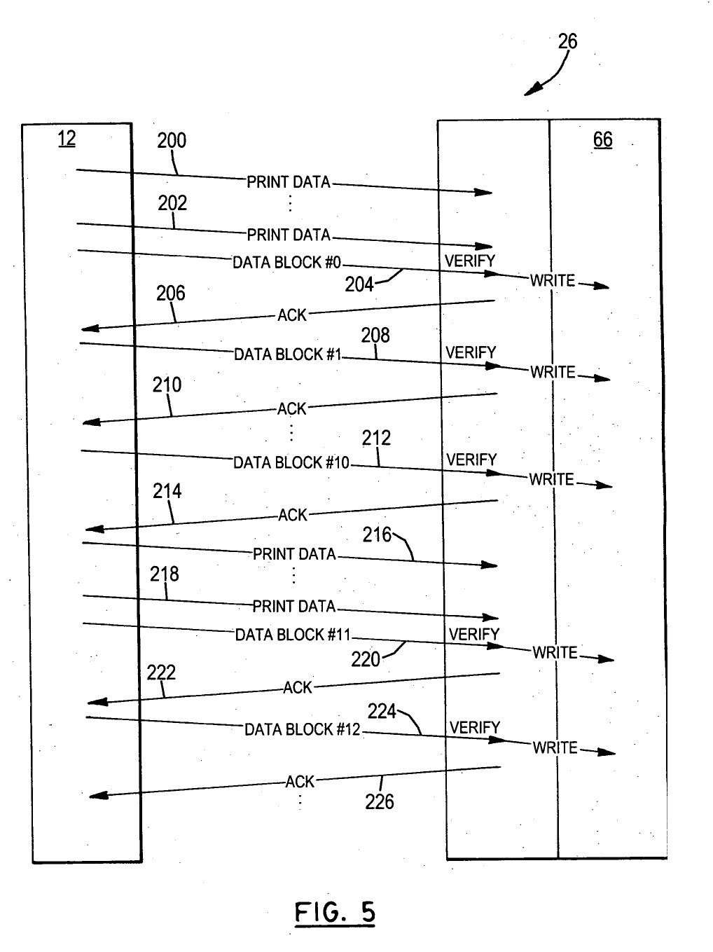

Turning now to FIGS. 5 to 7, sequence diagrams illustrating events that may occur during a firmware update are shown. For example, FIG. 5 shows the host device 12 transmitting print data to the printing device 26 (arrows 200 and 202). Arrow 204 confirms that the firmware update procedure has been initiated by the host device 12 upon completion of the print job, that the first data block has been selected and transmitted to the printing device 26 and that the data block has been verified and written to memory by the printing device. Upon receipt of the acknowledgement message (ACK) (arrow 206), the host device 12 transmits the next data block (arrow 208). This exchange of data blocks and acknowledgement messages continues (arrows 210 to 214) until the host device 12 receives another print job whereat the host device 12 immediately suspends the firmware update procedure and transmits the print data to the printing device 26 (arrows 216 and 218). Once the print job has been completed, the host device 12 resumes transmitting the data blocks to the printing device 26 at the point where the firmware update procedure was suspended (arrows 220 to 226).

As can be seen, print jobs are essentially given higher priority than firmware updates, as is particularly important to ensure quick and efficient processing of customer transactions.

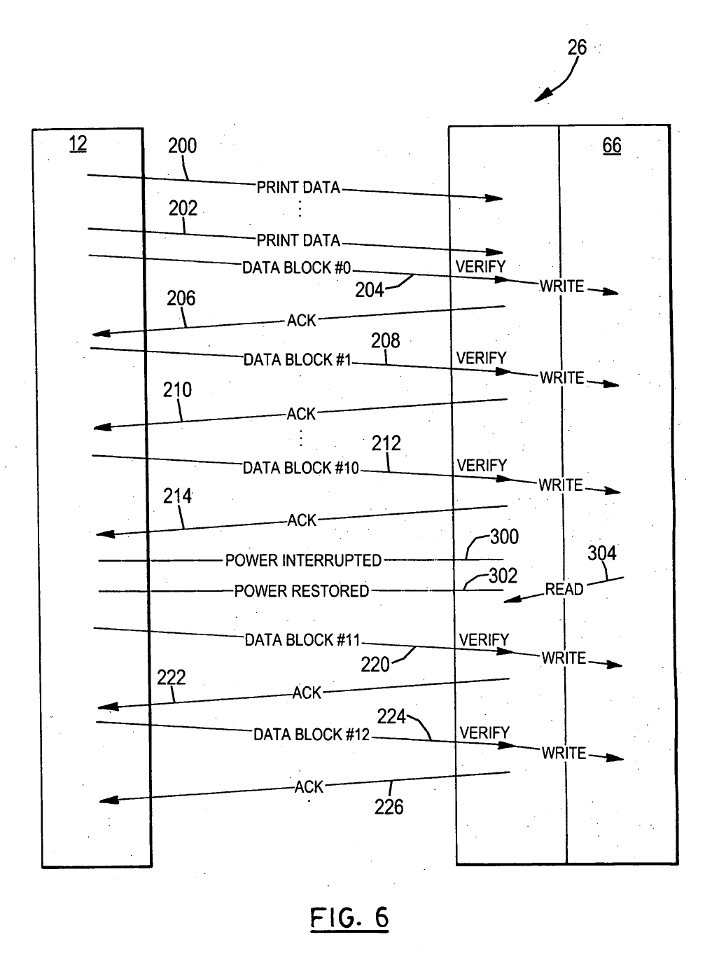

FIG. 6 is a sequence diagram showing the operation of the host device 12 and printing device 26 when a power interruption occurs during the firmware update (arrow 300). Upon power restoration (arrow 302), the microcontroller 60 reads the state of the non-volatile memory 66 to determine the current state of the firmware update (arrow 304) so that when the host device 12 automatically resumes the firmware update procedure and sends the next data block in the sequence (arrow 220), the received data block can be correctly verified by the microcontroller 60.

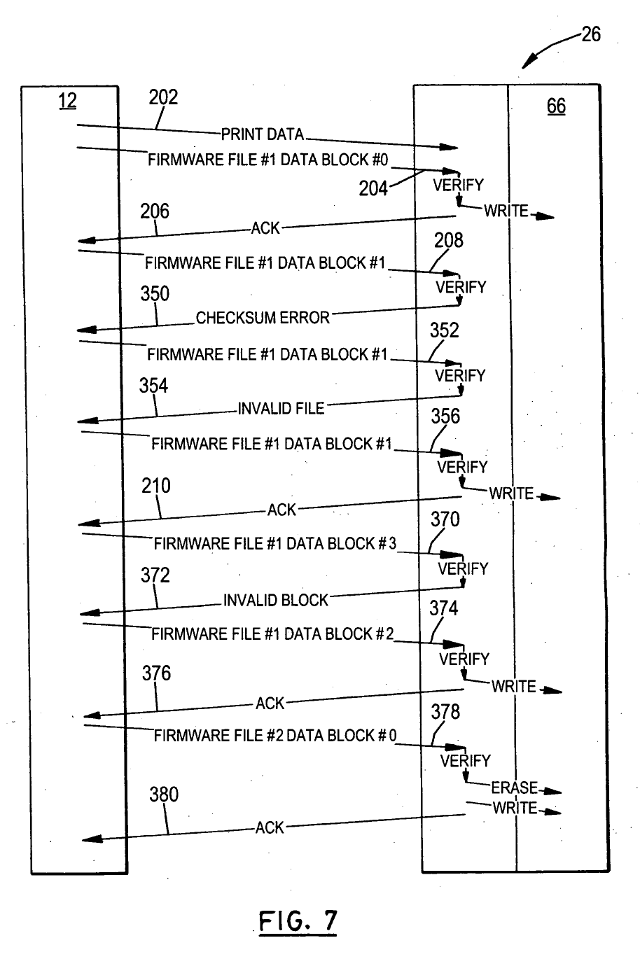

FIG. 7 is a sequence diagram showing the operation of the host device 12 and printing device 26 when a number of errors occur during verification. In this case, during verification of the data block identified by arrow 208, a checksum error is detected by the microcontroller 60 and a checksum error message is returned to the host device 12 (arrow 350). The host device 12 in response to the checksum error message retransmits the data block (arrow 352). During verification of the retransmitted data block, an invalid file error is detected by the microcontroller 60 and an invalid file error message is returned to the host device (arrow 354). The host device 12 in response to the invalid file error message retransmits the data block yet again (arrow 356). In this instance during verification the data block is properly verified and written to memory by the microcontroller 60 and an acknowledgement message is returned to the host device 12 (arrow 210).

Upon receipt of the acknowledgement message, the host device 12 transmits a data block out of sequence (arrow 370). In this case, the microcontroller 60 during verification detects an invalid block number and returns an invalid block number error message to the host device 12 (arrow 372). Host device 12 in response to the invalid block number error message transmits the proper data block to the printing device 26 (arrow 374). The microcontroller 60 in turn verifies the data block and returns an acknowledgement message to the host device (arrow 376). At arrow 378, host device 12 begins a new firmware update including firmware to replace the partially loaded firmware by sending the first data block of the new firmware (arrow 378). The microcontroller 60 in response verifies the data block, erases the existing partially loaded firmware, writes the data block to memory and returns an acknowledgement message to the host device 12 (arrow 380).

If the host device 12 transmits printer firmware to the printer interface during the firmware update procedure, upon completion of the firmware update procedure, the printer interface 50 initiates a printer firmware update procedure to transmit the printer firmware to the printer 52. The printer firmware update procedure is preferably carried out in the manner described in Applicants' co-pending application entitled “Method Of Updating Printer Firmware And Printing Device Employing The Method”, filed on even date herewith and assigned to the present assignee, the content of which is incorporated herein by reference.

Although the firmware update procedure is described as being suspended immediately to accommodate a print job, the firmware update procedure can be terminated after the last data block transmitted by the host device has been acknowledged by the printing device. In this manner, re-sending of the last sent data block is avoided.

As will be appreciated, firmware in the context of the present application includes any type of resource data or code to be loaded into the printing device.

Although a specific POS environment is shown and described, those of skill in the art will appreciate that this is for ease of illustration only. The firmware update procedure may be used in other printing environments where firmware is to be loaded from a host device into a printing device. The printer interface need not be readily removable from the printer. Rather, the printing device may include a printer interface that is more tightly integrated with the printer. Also, the firmware update method is suitable for use with virtually any type of printer such as for example dot matrix printers, thermal printers, ink jet printers, laser printers etc.

The firmware update procedure can also be suspended to accommodate other printer tasks deemed to be higher in priority than firmware updates.

Although embodiments have been described, those of skill in the art will appreciate that the variations and modifications may be made without departing from the spirit and scope thereof as defined by the appended claims.

What is claimed is:

1. A method of transferring firmware from a host device to a printing device comprising:
sending firmware data blocks forming said firmware to said printing device in succession;
in the event of an interruption, suspending sending of said data blocks; and
upon completion of said interruption, resuming sending of said data blocks while avoiding re-sending previously sent data blocks.

2. The method of claim 1 wherein sending of said data blocks is suspended every time an interruption occurs.

3. The method of claim 2, wherein said interruption is a power outage, sending of said data blocks being resumed automatically upon power restoration.

4. The method of claim 2, wherein said interruption is a print job destined for said printing device.

5. The method of claim 4 further comprising sending said print job to said printing device while sending of said data blocks is suspended, sending of said data blocks being resumed automatically upon completion of said print job.

6. The method of claim 5 further comprising partitioning said firmware into sequential data blocks and sending said data blocks to said printing device in sequence.

7. The method of claim 6 wherein said firmware is partitioned into said data blocks by said host device.

8. A method of transferring firmware from a host device to a printing device comprising:
sending data blocks forming said firmware to said printing device in succession, each data block being sent only upon confirmation of receipt of the previously sent data block;
upon receipt of a priority task destined for said printing device, suspending sending of said data blocks and transmitting said priority task to said printing device; and
upon completion of said priority task automatically resuming sending of said data blocks.

9. The method of claim 8 wherein said sending is suspended immediately upon receipt of said priority task.

10. The method of claim 8 wherein said sending is suspended upon receipt of confirmation of the last sent data block.

11. The method of claim 8 wherein each data block received by said printing device is verified prior to said confirmation being generated and sent to said host device.

12. The method of claim 11 wherein during verification, each data block is checked for at least one of checksum errors, format errors and sequence errors.

13. The method of claim 12 wherein during verification, each data block is checked for each of checksum errors, format errors and sequence errors.

14. The method of claim 8 wherein said priority task is a print job.

15. The method of claim 14 wherein each data block received by said printing device is verified prior to said confirmation being generated and sent to said host device.

16. The method of claim 15 wherein during verification, each data block is checked for at least one of checksum errors, format errors and sequence errors.

17. The method of claim 16 wherein during verification, each data block is checked for each of checksum errors, format errors and sequence errors.

18. The method of claim 16 wherein said sending is suspended immediately upon receipt of said priority task.

19. The method of claim 16 wherein said sending is suspended upon receipt of confirmation of the last sent data block.

20. The method of claim 8 wherein said sending of data blocks is resumed at the point where sending was suspended.

21. The method of claim 20 wherein said sending is suspended immediately upon receipt of said priority task.

22. The method of claim 20 wherein said sending is suspended upon receipt of confirmation of the last sent data block.

23. The method of claim 20 wherein said priority task is a print job.

24. The method of claim 23 wherein each data block received by said printing device is verified prior to said confirmation being generated and sent to said host device.

25. The method of claim 24 wherein during verification, each data block is checked for at least one of checksum errors, format errors and sequence errors.

26. The method of claim 20 further comprising:
following a transmission interruption, automatically resuming sending of data blocks at the point where sending was interrupted.

27. The method of claim 26 wherein said transmission interruption is the result of a power outage.

28. In a point-of-sale system including a host device and at least one printing device including a printer interface and a printer, a method of updating firmware stored in said printing device comprising:
at said host device, segmenting firmware into a sequence of data blocks;
transmitting said data blocks of said sequence in succession to said printing device with each successive data block being transmitted only upon verification of the previously sent data block by said printing device;
suspending transmission of said data blocks upon receipt of each print job destined for said printing device;
transmitting each said print job to said printing device; and
upon completing each said print job, automatically resuming transmission of said data blocks thereby to complete updating of said firmware without delaying processing of print jobs destined for said printing device.

29. The method of claim 28 wherein during verification, each data block is checked for at least one of checksum errors, format errors and sequence errors.

30. The method of claim 29 wherein during verification, each data block is checked for each of checksum errors, format errors and sequence errors.

31. The method of claim 28 wherein said sending is suspended immediately upon receipt of said print job.

32. The method of claim 28 wherein said sending is suspended upon receipt of confirmation of the last sent data block.

33. The method of claim 28 further comprising:
following a transmission interruption, automatically resuming sending of data blocks at the point where sending was interrupted.

34. The method of claim 33 wherein said transmission interruption is the result of a power outage.

35. A system comprising:
a printing device executing firmware stored therein and responsive to print jobs to print information on a medium; and
a host device generating print jobs for transmission to said printing device, said host device executing a firmware update procedure when firmware in said printing device is to be updated, during said firmware update procedure said host device sending updated firmware in successive blocks to said printing device, said host device suspending said firmware update procedure when a print job is generated for said printing device and resuming said firmware update procedure automatically upon completion of said print job.

36. A system according to claim 35 wherein said firmware update procedure is resumed at the point where it was interrupted.

37. A system according to claim 36 wherein said printing device confirms receipt of said blocks to said host device.

38. A system according to claim 37 wherein said firmware update procedure is suspended automatically when said print job is generated.

39. A system according to claim 37 wherein said firmware update procedure is suspended when said printing device confirms the last sent data block.

40. A system according to claim 36 wherein said printing device includes a printer interface and a printer.

41. A system according to claim 37 wherein said system is a point-of-sale station.
